(19) United States
(12) Patent Application Publication
(10) Pub. No.: US 2022/0381952 A1
(43) Pub. Date: Dec. 1, 2022

(54) HEAD MOUNTED DISPLAYS WITH AN ANTI-REFLECTION LAYER

(71) Applicant: HEWLETT-PACKARD DEVELOPMENT COMPANY, L.P., Spring, TX (US)

(72) Inventors: Travis Shih, Taipei City (TW); Johnny Hung, Taipei City (TW)

(21) Appl. No.: 17/333,668

(22) Filed: May 28, 2021

(51) Int. Cl. G02B 1/11; G02B 5/00; G02B 5/30; G02B 25/00

(52) U.S. Cl. CPC G02B 1/11; G02B 5/003; G02B 5/3025; G02B 25/001

(57) ABSTRACT

In example implementations, an apparatus is provided. The apparatus includes a display, an eye barrel, an anti-reflection layer, and a lens. A first end of the eye barrel is coupled to the display. The anti-reflection layer is applied to an inner surface of the eye barrel. The lens is coupled to a second end of the eye barrel.

### BACKGROUND

Virtual reality devices are becoming ubiquitous. Virtual reality devices include various components that allow a user to consume virtual reality applications, such as video games. The virtual reality devices may include head mounted displays, hand held controllers, wearable sensors, and the like. A head mounted display may be worn on or over the face of a user. The hand held controllers may allow a user to interact with objects in the applications shown on the head mounted display.

### BRIEF DESCRIPTION OF THE DRAWINGS

FIG. 1 is a block diagram of an example virtual reality (VR) system of the present disclosure;

FIG. 2 is a block diagram of a top cross-sectional view of a head mounted display with an anti-reflection layer that illustrates example light rays of the present disclosure;

FIG. 3 is a block diagram of a top cross-sectional view of a head mounted display with a suede microfiber anti-reflection layer of the present disclosure;

FIG. 4 is a block diagram of a top cross-sectional view of a head mounted display with an absorber microstructure anti-reflection layer of the present disclosure; and

FIG. 5 is a block diagram of a top cross-sectional view of a head mounted display with a circular polarizer anti-reflection layer of the present disclosure.

### DETAILED DESCRIPTION

Examples described herein provide a head mounted display (HMD) with an anti-reflection layer. As discussed above, virtual reality devices include various components that allow a user to consume virtual reality applications, such as video games. The virtual reality devices may include HMDs, hand held controllers, wearable sensors, and the like. An HMD may be worn on or over the face of the user.

The display in the HMD may generate light. Light that is reflected inside of the eye barrel of the HMD can create ghosting effects and/or glare that is distracting for a user. Previous generations of displays in the HMDs had a relatively low resolution, and as a result the effect of these light reflections would cause minimal distractions. However, as the resolution of the displays in the HMDs improves, these lighting effects created by reflections inside of the eye barrel of the HMD can be more noticeable and distracting.

Some previous methods attempted to create a rough surface in the surfaces of the eye barrel of the HMD. The eye barrel would be molded with a textured or rough surface to reduce the amount of reflection. However, molding the eye barrel with a rough surface would cause manufacturers to increase a draft angle at the outer corners of the eye barrel to allow the eye barrel to be removed from the mold without damage. Specifically, the greater the amount or the deeper the texture that was added to the surface of the eye barrel, the greater the draft angle that was required.

Increasing the draft angle may cause the display area of the HMD to become smaller, or the overall size of the HMD to increase, to maintain a larger display. Moreover, the increased draft angle may create weak points that can cause the eye barrel or the HMD to be easily damaged.

The present disclosure provides an anti-reflection layer that can be added to the inner surface of the eye barrel of the HMD to absorb incident light rays. This may help to reduce the amount of ghosting (e.g., an artifact of an image trail behind a moving object in a video image) or glare caused by incident light rays that are reflected off of the inner surface of the eye barrel.

By applying the anti-reflection layer after the eye barrel is formed, the eye barrel can be molded to any desired shape with a minimal draft angle due to the smooth surface of the eye barrel. The anti-reflection layer can then be applied to the inner surface of the eye barrel to absorb the incident light rays.

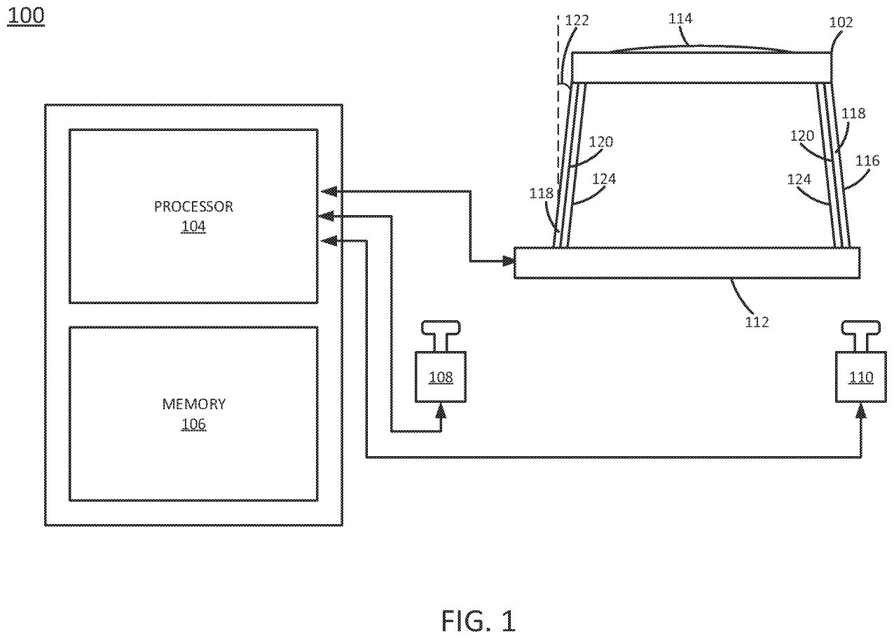

FIG. 1 illustrates an example virtual reality (VR) system 100 of the present disclosure. In an example, the VR system 100 may include a head mounted display (HMD) 102, a processor 104, a memory 106, and controllers 108 and 110. Although the processor 104 and the memory 106 are illustrated as being part of a separate computing device or housing in FIG. 1, it should be noted that the processor 104 and the memory 106 may be located within the HMD 102 as part of an all-in-one or stand-alone VR system 100 that does not use a separate computing device.

The processor 104 may be communicatively coupled to the HMD 102, the memory 106, and the controllers 108 and 110. The processor 104 may load and execute applications (e.g., stored in the memory 106) that are consumed by a user via the HMD 102. For example, the applications may be video games, VR training programs, and the like.

The processor 104 may take interaction inputs from the controllers 108 and 110 and translate the inputs as commands and/or movements that are shown in the HMD 102. For example, the controllers 108 and 110 may be used to move an avatar shown in the HMD 102, interact with items in the VR application, and the like. The controllers 108 and 110 may include haptic feedback to increase the realism of the VR experience.

In an example, the HMD 102 may include a display 112 and a lens 114 within a housing 116 of the HMD 102. An eye barrel 118 may be coupled to the display 112 and the lens 114 and provide spacing between the display 112 and the lens 114. For example, the display 112 may be coupled to a first end of the eye barrel 118 and the lens 114 may be coupled to a second end of the eye barrel 118. The first end of the eye barrel 118 may be located on an opposite end from the second end of the eye barrel 118.

The display 112 may present graphics and/or images associated with a VR application executed by the processor 104. The lens 114 may be used to adjust optical properties of the display 112. For example, the lens 114 may be a Fresnel lens. The lens 114 may help to adjust the perceived depth of images viewed on the display 112.

Although example components for the HMD 102 are illustrated in FIG. 1, it should be noted that the HMD 102 may include other components that are not shown. For example, the HMD 102 may include a microphone, speakers, additional input/output interfaces, and the like.

The display 112 may generate light that is emitted towards the lens 114. The light generated by the display 112 may also be emitted in various directions and reflect off of inner surfaces 120 of the eye barrel 118. The reflection of the light may cause ghosting or glare, as described above, that may cause an undesirable user experience. The ghosting or glare may reduce the perceived image quality generated by the display 112.

Previous designs used rough surfaces on the eye barrel 118 to reduce the reflection caused by light emitted by the display 112. For example, the surface of the previously designed eye barrels may include pits or raised textures. However, creating rough or textured surfaces may force the manufacturer to increase a draft angle 122 of the eye barrel 118. The greater the number of textures and the deeper the texture that is formed into the surface of the eye barrel 118, the more the draft angle 122 is increased to allow the eye barrel 118 to be removed from the mold.

Increasing the draft angle 122 may create undesirable shapes (e.g., very wide to narrow shapes). Increasing the draft angle 122 may also create physical weak points in the eye barrel 118 as material may be removed to accommodate the increased draft angle 122.

The present disclosure provides an anti-reflection layer 124 inside of the eye barrel 118. As a result, the draft angle 122 may be minimized and the eye barrel 118 can be manufactured with a smooth surface. The anti-reflection layer 124 may be added to the inner surface 120 after the eye barrel 118 is manufactured.

In some instances, the anti-reflection layer 124 may be shipped directly to the clean room where the eye barrel 118 is manufactured. As a result, the anti-reflection layer 124 may be added to the inner surface 120 with minimal debris and/or dust being trapped inside of the eye barrel 118 that could interfere with the image shown by the display 112. The anti-reflection layer 124 may be coupled to the inner surface 120 of the eye barrel 118 via glue or an adhesive.

In addition, the separate anti-reflection layer 124 may allow any HMD 102 to be retro-fitted to reduce ghosting and/or glare. For example, as display resolutions are increased, the anti-reflection layer 124 may be added to an existing eye barrel design rather than having to create a new mold with higher draft angles to accommodate added texture to reduce ghosting and/or glare.

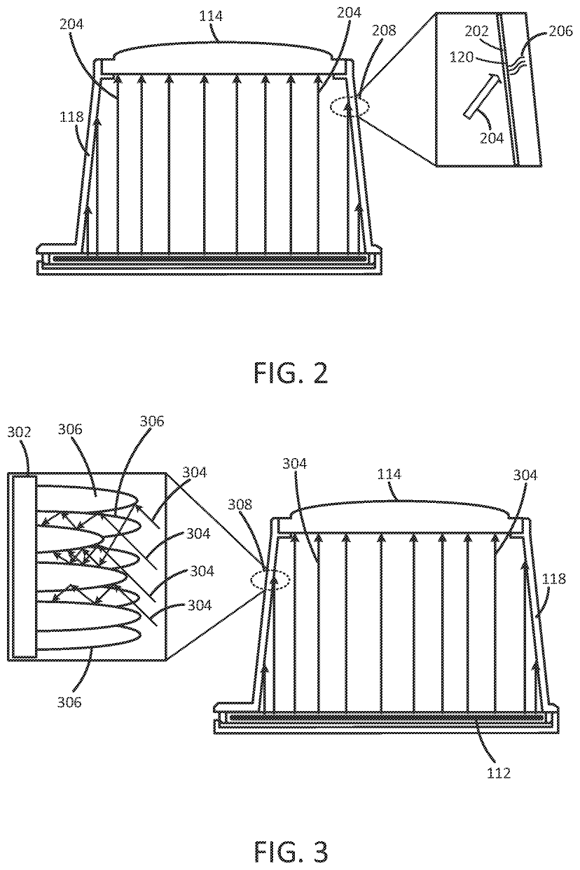

In an example, the anti-reflection layer 124 may be a coating, a physical structure, or an optical layer. FIGS. 2-5 illustrate different examples of the anti-reflection layer 124. For example, FIG. 2 illustrates an example of the anti-reflection layer 124 as a coating 202. The coating may be a black-matte coating. For example, the black-matte coating may be painted, sprayed, applied as a paste, and the like, onto the inner surface 120 of the eye barrel 118. The coating 202 may be applied to the inner surface 120 of the eye barrel 118 before the eye barrel 118 is coupled to the display 112 and the lens 114.

FIG. 2 illustrates an example of how some light rays 204 may travel within the eye barrel 118. As can be seen in FIG. 2, some of the light rays 204 may reflect off of the inner surface 120. A close-up view as highlighted by a dashed circle 208 illustrates how the light ray 204 can be absorbed by the coating 202.

In some examples, the light rays 204 may contact the coating 202 at an angle. As the light rays 204 contact the coating 202, the light rays 204 may be absorbed by the coating 202, as shown by lines 206. As a result, the light rays 204 are not reflected back towards the lens 114.

FIG. 3 illustrates one example of the anti-reflective layer 124 deployed as a structural anti-reflection layer. In an example, the anti-reflective layer 124 may be a suede cloth or a micro-fiber cloth 302. The micro-fiber cloth 302 may be applied to the inner surface 120 of the eye barrel 118 before the eye barrel 118 is coupled to the display 112 and the lens 114.

The micro-fiber cloth 302 may include a plurality of individual fibers 306. The fibers 306 may be arranged on the surface of the micro-fiber cloth 302 and be arranged adjacent to one-another. The fibers 306 may have different sizes and dimensions.

FIG. 3 illustrates an example of how some light rays 304 may travel within the eye barrel 118. As can be seen in FIG. 3, some of the light rays 304 may reflect off of the inner surface 120. A close-up view as highlighted by a dashed circle 308 illustrates how the light ray 304 can be absorbed by the micro-fiber cloth 302.

In some examples, the light rays 304 may contact the micro-fiber cloth 302 at an angle that allows the light ray 304 to contact a fiber 306 of the micro-fiber cloth 302. The light ray 304 may be reflected off of the fiber 306 towards an adjacent fiber 306. The light ray 304 may continue to be reflected between the two adjacent fibers 306 of the micro-fiber cloth 302 until the light ray 304 is absorbed and prevented from being reflected back out towards the lens 114.

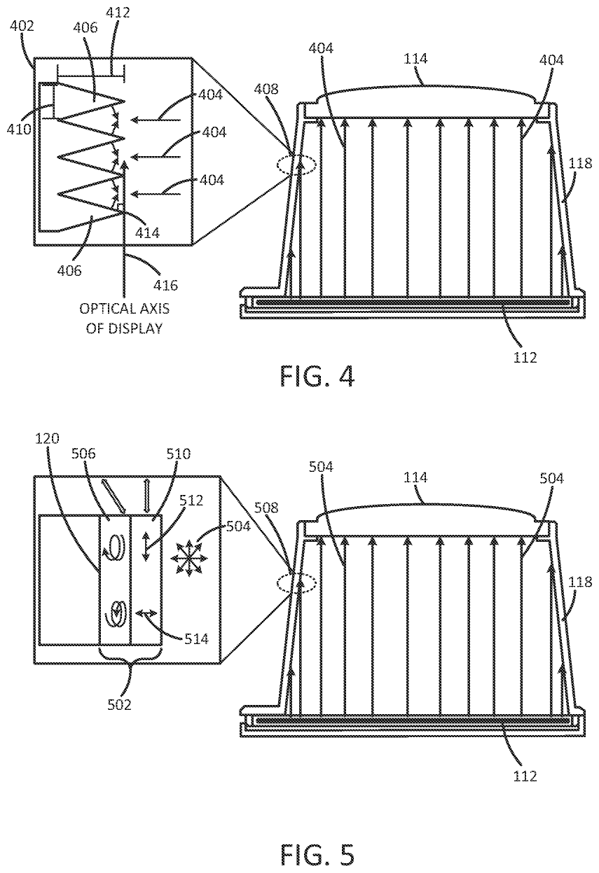

FIG. 4 illustrates another example of the anti-reflective layer 124 deployed as a structural anti-reflection layer. In an example, the anti-reflective layer 124 may be an absorber microstructure 402. The absorber microstructure 402 may be applied to the inner surface 120 of the eye barrel 118 before the eye barrel 118 is coupled to the display 112 and the lens 114.

The absorber microstructure 402 may include a plurality of microstructures 406. The microstructures 406 may be arranged symmetrically or spaced evenly throughout the entire surface of the absorber microstructure 402 and onto the inner surface 120 of the eye barrel 118. For example, the microstructures 406 may be arranged in arrays that are adjacent to one another. In an example, all of the microstructures 406 may have the same dimensions.

In an example, the microstructures 406 may be fabricated as a three-dimensional polygon. In an example, the microstructures 406 may be formed as a pyramidal structure. The pyramidal structure may be similar to pyramids that are used in a radio frequency (RF) anechoic chamber to prevent reflection of radiation.

In an example, a peak 414 of the pyramidal structure may be arranged to be pointed towards a center of the eye barrel 118. For example, the peak 414 may be arranged to be normal (e.g., approximately 90 degrees, or perpendicular) to an optical axis 416 of the display 112. In other words, if portions of the inner surface 120 of the eye barrel 118 are slanted or angled, the microstructures 406 may be angled or tilted to position the peak 414 to still be normal to the optical axis 416 of the display 112.

However, the dimensions of the microstructures 406 in the eye barrel 118 may be tens or hundreds of micrometers. The exact dimensions of the microstructures 406 may be a function of the light rays 404 emitted by the display 112. For example, dimensions (e.g., a height 412 and a width 410) of the microstructures 406 may be based on an intensity of the light rays 404, angle of incidence of the light rays 404, a frequency of the light rays 404, and the like.

The microstructures 406 may be manufactured using techniques that can produce a high aspect ratio (e.g., the height 412 to the width 410 ratio of greater than 2:1). An example of a high aspect ratio manufacturing technique may include lithography electroforming micro molding also known by the German technique called “lithographie gavlanoformung, aboformung” or (LIGA). The LIGA technique may include general processing steps of lithography, electroplating, and molding.

In an example, the absorber microstructure 402 may be formed and then applied to the inner surface 120 of the eye barrel 118. In another example, the absorber microstructure 402 may be formed as an integral part of the inner surface 120 of the eye barrel 118. For example, the inner surface 120 of the eye barrel 118 may provide the surface or substrate for the microstructures 406 to be formed onto via the LIGA technique.

FIG. 4 illustrates an example of how some light rays 404 may travel within the eye barrel 118. As can be seen in FIG. 4, some of the light rays 404 may reflect off of the inner surface 120. A close-up view as highlighted by a dashed circle 408 illustrates how the light ray 404 can be absorbed by the absorber microstructure 402.

In some examples, the light rays 404 may contact the absorber microstructure 402 at an angle that allows the light ray 404 to contact a microstructure 406 of the absorber microstructure 402. The light ray 404 may be reflected off of the microstructure 406 towards an adjacent microstructure 406. The light ray 404 may continue to be reflected between the two adjacent microstructure 406 of the absorber microstructure 402 until the light ray 404 is absorbed and prevented from being reflected back out towards the lens 114.

FIG. 5 illustrates one example of the anti-reflective layer 124 deployed as an optical anti-reflection layer. In an example, the anti-reflective layer 124 may be a polarizer 502. For example, the polarizer 502 may filter light that is received at certain angles to prevent the light from being reflected. The polarizer 502 may be applied to the inner surface 120 of the eye barrel 118 before the eye barrel 118 is coupled to the display 112 and the lens 114.

In an example, the polarizer 502 may be a circular polarizer. The circular polarizer may include a quarter wave plate 506 and a linear polarizer 510. The linear polarizer 510 may allow light rays at a certain angle of incidence to pass through, while blocking light rays 504 at other angles of incidence. The angles may be measured around an axis of polarization of the linear polarizer 510. In an example, the linear polarizer 510 may allow light rays at 0 degrees or 180 degrees (e.g., vertically straight, or up and down along the page, as shown by an arrow 512) to pass through.

The quarter wave plate 506 may rotate the light ray 504 that is passed through the linear polarizer 510 by approximately 45 degrees. When the light ray 504 is reflected and passed back through the quarter wave plate 506, the light ray may be rotated another approximately 45 degrees. For example, the light ray 504 may enter the linear polarizer 510 at an angle of 0 degrees, but may try to exit at 90 degrees (e.g., horizontal as shown by an arrow 514) after being processed by the quarter wave plate 506. However, since the linear polarizer 510 does not allow light rays 504 at 90 degrees to pass through, the reflected light ray 504 is blocked from passing through the linear polarizer 510 back towards the lens 114.

FIG. 5 illustrates an example of how some light rays 404 may travel within the eye barrel 118. As can be seen in FIG. 5, some of the light rays 504 may reflect off of the inner surface 120. A close-up view as highlighted by a dashed circle 508 illustrates how the light ray 504 can be absorbed by the polarizer 502.

In some examples, the light rays 504 may be emitted by the display 112 at various different angles as shown in the close-up view 508. However, the linear polarizer 510 may allow light rays 504 at a particular angle (e.g., an angle shown by the arrow 512) to pass through the linear polarizer 510. The light ray 504 may then pass through the quarter wave plate 506 to be rotated at approximately 45 degrees and to travel in a clockwise spiral towards the inner surface 120.

The light ray 504 may be reflected by the inner surface 120 to travel back towards the quarter wave plate 506 in a counter clockwise spiral. The light ray 504 may pass through the quarter wave plate 506 to be rotated another approximately 45 degrees. As a result, the light ray 504 may arrive at the linear polarizer 510 at an approximately 90 degree angle (e.g., in a direction similar to the arrow 514). The linear polarizer 510 may block the light ray 504 that is at approximately 90 degrees from passing through the linear polarizer 510. As a result, the light ray 504 may be prevented from reflecting back into the eye barrel 118 and towards the lens 114.

In an example, polarizers 502 with different linear polarizers 510 may be deployed throughout the inner surface 120 of the eye barrel. The different linear polarizers 510 may be set to capture light rays 504 at different angles (e.g., angles that are not normal to the lens 114). As a result, the light rays 504 that are not normal to the lens 114 may be absorbed to prevent glares and/or ghosting.

Thus, the present disclosure provides various types of anti-reflective layers 124 that can be applied to the inner surface 120 of the eye barrel 118 of an HMD 102. The anti-reflective layers 124 of the present disclosure may allow manufacturers to maintain a high draft angle 122 that allows the shape and/or design of the HMD 102 to appear more symmetrical. In addition, the anti-reflective layers 124 of the present disclosure may provide a lower cost method or design to reduce undesirable glare and/or ghosting caused by reflections of light rays emitted by the display 112 towards the lens 114. This may allow the display 112 to produce a clearer image with a higher perceived image quality.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An apparatus, comprising:
a display;
an eye barrel, wherein a first end of the eye barrel is coupled to the display;
an anti-reflection layer applied to an inner surface of the eye barrel; and
a lens coupled to a second end of the eye barrel.

2. The apparatus of claim 1, wherein the anti-reflection layer comprises a matte black coating.

3. The apparatus of claim 1, wherein the anti-reflection layer comprises a microfiber suede.

4. The apparatus of claim 1, wherein the anti-reflection layer comprises a layer of light absorbing microstructures.

5. The apparatus of claim 1, wherein the anti-reflection layer comprises a polarizer.

6. An apparatus, comprising:
a display;
an eye barrel, wherein a first end of the eye barrel is coupled to the display;
a structural anti-reflection layer applied to an inner surface of the eye barrel; and
a lens coupled to a second end of the eye barrel.

7. The apparatus of claim 6, wherein the structural anti-reflection layer comprises a microfiber suede.

8. The apparatus of claim 6, wherein the structural anti-reflection layer comprises a layer of light absorbing microstructures.

9. The apparatus of claim 8, wherein the layer of light absorbing microstructures comprises a plurality of pyramids.

10. The apparatus of claim 9, wherein the plurality of pyramids is arranged in arrays which are adjacent to one another.

11. The apparatus of claim 9, wherein a peak of each pyramid of the plurality of pyramids is positioned to be normal to an optical axis of the display.

12. The apparatus of claim 9, wherein an aspect ratio of each pyramid of the plurality of pyramids is greater than 2:1.

13. An apparatus, comprising:
a display;
an eye barrel, wherein a first end of the eye barrel is coupled to the display;
an optical anti-reflection layer applied to an inner surface of the eye barrel; and
a lens coupled to a second end of the eye barrel.

14. The apparatus of claim 13, wherein the optical anti-reflection layer comprises a light polarizer.

15. The apparatus of claim 14, wherein the light polarizer comprises a circular light polarizer.
